(19) United States
(12) Patent Application Publication
(10) Pub. No.: US 2014/0049985 A1
(43) Pub. Date: Feb. 20, 2014

(54) ANISOTROPIC HEAT DISSIPATION IN A BACKLIGHT UNIT

(71) Applicants: Ko-Chun CHEN, Kaohsiung City (TW); Chiu-Lang LIN, Fongshan City (TW)

(72) Inventors: Ko-Chun CHEN, Kaohsiung City (TW); Chiu-Lang LIN, Fongshan City (TW)

(21) Appl. No.: 13/970,221

(22) Filed: Aug. 19, 2013

Related U.S. Application Data
(60) Provisional application No. 61/684,153, filed on Aug. 17, 2012.
(60) Provisional application No. 61/694,265, filed on Aug. 29, 2012.

(51) Int. Cl. F21V 8/00; F21V 29/00

(52) U.S. Cl. CPC G02B 6/0085; F21V 29/004
USPC 362/611; 362/97.1

(57) ABSTRACT

A backlight unit with a light source, a light guiding plate, a reflective film and an anisotropic heat dissipation layer is disclosed. At least some embodiments provide a display panel including the backlight unit and methods for reducing the temperature of a backlight unit by the anisotropic heat dissipation layer.

### CROSS-REFERENCE TO RELATED APPLICATIONS

This application claims the benefit of U.S. Provisional Patent Application No. 61/684,153, filed on 17 Aug. 2012 and U.S. Provisional Patent Application No. 61/694,265, filed on 29 Aug. 2012, the entire disclosures of these disclosures being incorporated herein by reference.

### BACKGROUND OF THE INVENTION

Non-emissive displays, such as liquid crystal displays (LCDs), do not produce light themselves. Therefore, a special light source, such as a backlight unit (BLU), is required to produce a visible image. BLUs are used in various electronic devices, such as mobile phones, notebook computers, computer monitors and LCD televisions.

Typical BLUs comprise a light source, such as a light emitting diode (LED), a light guide, a diffuser sheet, a prism film and a reflective film, such as a reflective polarizer. Based on the location of the light sources, BLUs can be classified into two categories: (1) an edge type BLU such as is illustrated in FIG. 1A and (2) a direct type BLU such as is illustrated in FIG. 1B. In the edge type BLU, the light source is adjacent to an edge of a light guiding plate, which directs the light emitted from the light source to the display panel through a prism sheet and a diffuser sheet. In the direct type BLU, the light source comprises a plurality of LED bars in parallel configuration directly below the LCD panel.

About 95% of the heat generated from the light source in a BLU is transmitted to the printed circuit board (PCB) associated with the light source. However, it is difficult to discharge the heat from the PCB in a short time due to the space limitation imposed by the reflective film around the light source.

### SUMMARY OF THE INVENTION

Some embodiments provide a more efficient heat dissipation device for use in conjunction with BLUs in LCD applications. Some embodiments are directed towards a backlight unit for use in conjunction with a display panel, such as an LCD display. In one embodiment, the BLU is constructed from a series of generally planar sheets or layers, each sheet or layer having an upper surface, a lower surface and at least one edge surface wherein the individual sheets or layers making up the BLU are sandwiched together such that the individual layers are positioned along their corresponding upper and lower surfaces. Typical layers of a BLU, such as the prism sheet and the diffuser sheet, are positioned such that the lower surface of the prism sheet is adjacent to the upper surface of the diffuser sheet. The upper surface of the light guide plate is positioned adjacent to the lower surface of the diffuser sheet, and in some embodiments, a light source is positioned adjacent to at least one edge of the light guide plate. The upper surface of a reflective film layer is positioned adjacent the lower surface of the light guide plate. The upper surface of an anisotropic heat dissipation layer is positioned adjacent the lower surface of the reflective film layer. An insulating film layer may be positioned such that its upper surface is positioned adjacent to the lower surface of the anisotropic heat dissipation layer.

In some embodiments, the anisotropic heat dissipation layer is a flexible exfoliated graphite sheet. The graphite sheet may in turn have a metal layer positioned adjacent to the graphite sheet's upper surface. The metal layer includes one or more layers of copper, nickel, chromium, gold, silver, tin, platinum and other similar materials or combinations thereof. In addition, the metal layer may be electroplated onto the upper surface of the anisotropic heat dissipation layer.

In some embodiments, the reflective film layer is configured to reflect heat with a reflectivity of at least 70%.

In some embodiments, the light source is positioned below the light guide plate. A printed circuit board having an upper surface and a lower surface is positioned below and electrically connected to the light source and the anisotropic heat dissipation layer is positioned proximate to the lower surface of the printed circuit board. The reflective film layer can be interposed between the lower surface of the printed circuit board and the upper surface of the anisotropic heat dissipation layer.

In some embodiments, there are methods to dissipate heat and reduce the internal temperature of the BLU. In one embodiment, an anisotropic heat dissipation layer is placed in direct physical contact or indirect contact (wherein there is a gap or one or more interposing layers) with a reflective film in an edge type BLU. Heat is first conducted from a light source to a light guide plate, then from the light guide plate to the reflective film and the anisotropic heat dissipation layer. Heat is then dissipated through the planar direction (i.e., X-Y direction in FIG. 9) of the anisotropic heat dissipation layer.

In another embodiment, an anisotropic heat dissipation layer is placed in direct physical contact or indirect contact (wherein there is a gap or one or more interposing layers) with a reflective film, wherein the anisotropic heat dissipation layer is positioned below the reflective film and the reflective film is positioned below a printed circuit board (PCB). Heat is conducted from the PCB to a reflective film, wherein a portion of the heat is reflected to the ambient air and the remaining heat passes through the thickness of the reflective film and/or the metal layer (i.e. Z direction in FIG. 10), then spreads through the planar direction (i.e., X-Y direction in FIG. 10) of the anisotropic heat dissipation layer.

### BRIEF DESCRIPTION OF THE DRAWINGS

Some features of at least some embodiments will become apparent in the following detailed description of at least some embodiments, with reference to the accompanying drawings, in which:

FIG. 1A illustrates an edge type BLU.

FIG. 1B illustrates a direct type BLU.

FIG. 2 illustrates schematically the cross section view of an edge type BLU with an anisotropic heat dissipation device.

FIG. 3 illustrates schematically the cross section view of a direct type BLU with an anisotropic heat dissipation device.

FIG. 4 illustrates schematically the cross section view of a display device including an edge type BLU in FIG. 2.

FIG. 5 illustrates schematically the cross section view of a display device including a direct type BLU in FIG. 3.

FIG. 6-8 illustrate schematically the various embodiments of the reflective film and the anisotropic heat dissipation layer in a BLU.

FIG. 9 illustrates schematically the heat dissipation pathway of an edge type BLU in FIG. 2.

FIG. 10 illustrates schematically the heat dissipation pathway of a direct type BLU in FIG. 3.

FIG. 11 illustrates schematically the various temperature measurement points of an edge type BLU in FIG. 2.

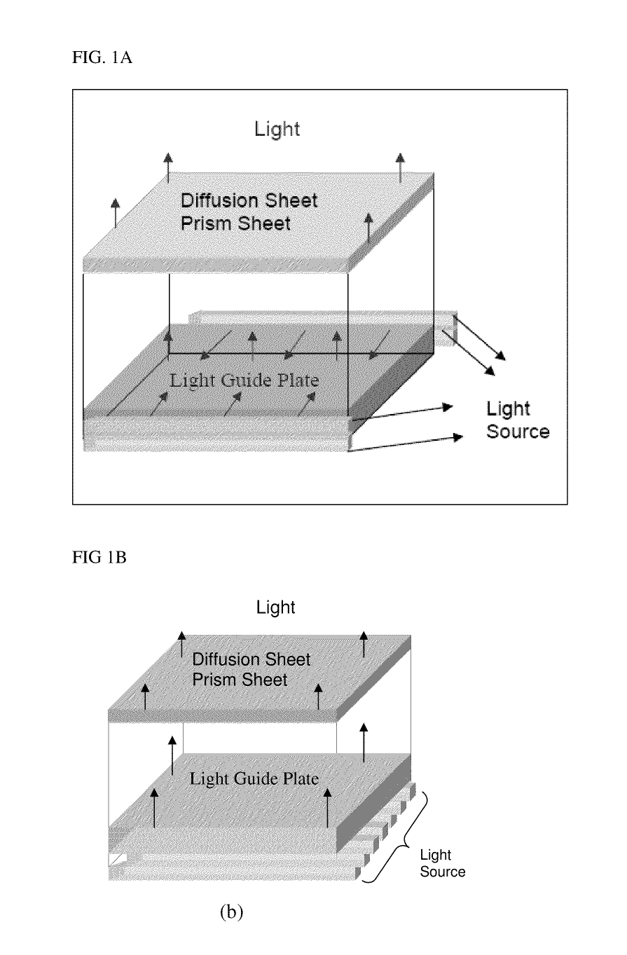

### DETAILED DESCRIPTION OF THE INVENTION

Embodiments include a BLU with an anisotropic heat dissipation layer to enhance heat dissipation and reduce the internal temperature of the BLU. In an exemplary embodiment, the dissipation layer substantially enhances heat dissipation and/or substantially reduces the internal temperature of the BLU as compared to that which would be the case in the absence of the dissipation layer. The BLU can be a direct type BLU or an edge type BLU. The BLU has applications in various electronic devices and non-emissive display devices, such as computers, notebooks, cellular phones, LCD or LED display panels, and the like. The BLU can be constructed from a series of generally planar sheets or layers, each sheet or layer having an upper surface, a lower surface and at least one edge surface wherein the individual sheets or layers making up the BLU are sandwiched together such that the individual layers are positioned along their corresponding upper and lower surfaces. Typical layers, such as the prism sheet and the diffuser sheet, are positioned such that the lower surface of the prism sheet is adjacent to the upper surface of the diffuser sheet. The upper surface of the light guide plate is positioned adjacent to the lower surface of the diffuser sheet. In one embodiment, a light source is positioned adjacent to at least one edge of the light guide plate, and the upper surface of a reflective film layer is positioned adjacent the lower surface of the light guide plate. The upper surface of an anisotropic heat dissipation layer is positioned adjacent the lower surface of the reflective film layer. An insulating film layer may be positioned such that its upper surface is positioned adjacent to the lower surface of the anisotropic heat dissipation layer.

In another embodiment, the light source is positioned below the light guide plate and electrically connected to a printed circuit board (PCB). The lower surface of the PCB is connected to a reflective film layer. The lower surface of the reflective film is positioned adjacent to the upper surface of an anisotropic heat dissipation layer. An insulating film layer may be positioned such that its upper surface is positioned adjacent to the lower surface of the anisotropic heat dissipation layer. Some additional aspects and embodiments are described below in more detail and in accordance with the following definitions.

### Definitions

As employed above and throughout the disclosure, the following terms, unless otherwise indicated, shall be understood to have the following meanings.

As used herein, the singular forms “a,” “an,” and “the” include the plural reference unless the context clearly indicates otherwise.

The BLUs described herein can, in some embodiments, comprise various sheets, layers, films or plates sandwiched together to form the BLU of at least some embodiments, and such terms as sheets, layers, films or plates may be used interchangeably in conjunction with the description of at least some embodiments as such would be understood by one of ordinary skill in the art.

The printed circuit boards (PCBs) described herein include, but are not limited to, flexible PCB and metal PCB.

### DETAILED DESCRIPTION

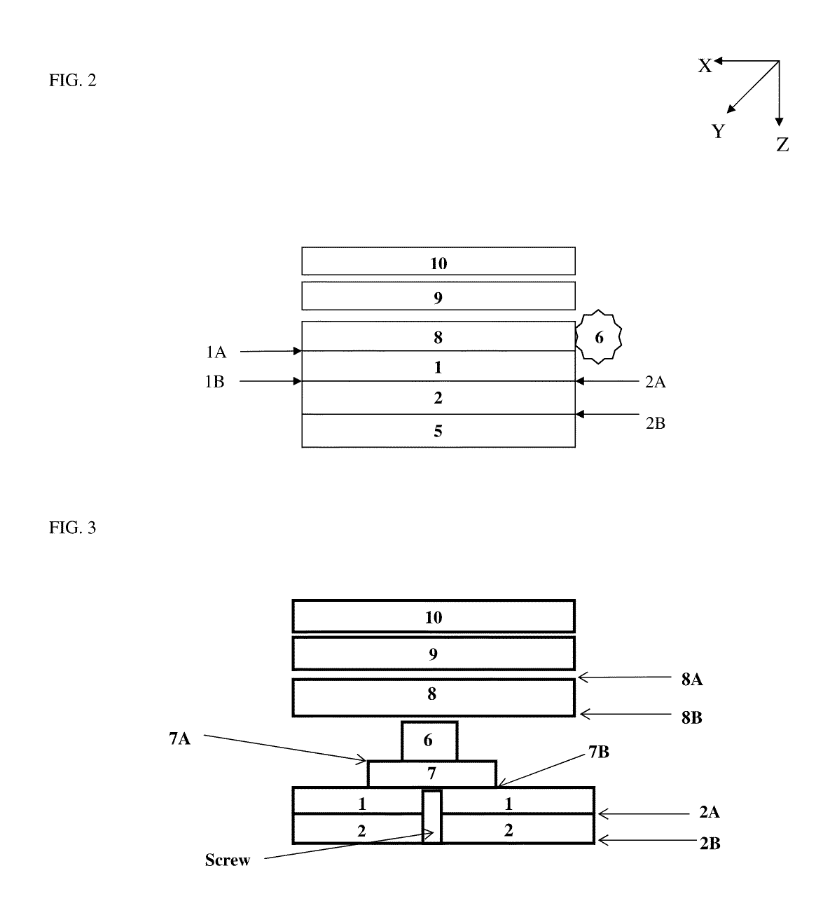

Referring to FIG. 2, in this embodiment the BLU is an edge type BLU including a prism sheet 10, a diffuser sheet 9, light source 6, a light guide plate 8, a reflective film 1, and an anisotropic heat dissipation layer 2. The light guide plate 8 has an upper surface 8A, a lower surface 8B, and one or more edge surfaces. Herein, the phrase “edge surface” refers to the lateral side surfaces (i.e., the minor surfaces, as contrasted to the major surfaces). The light source 6 is adjacent to at least one edge surface of the light guide plate 8. The reflective film 1 has an upper surface 1A, and a lower surface 1B, and similarly, the anisotropic heat dissipation layer 2 has an upper surface 2A, and a lower surface 2B. The reflective film 1 is interposed between the lower surface of the light guide plate 8B and the upper surface of the anisotropic heat dissipation layer 2A. In some embodiments, bottom surface of the anisotropic heat dissipation layer 2B is connected with an insulating film 5, which is discussed in more detail below.

Referring to FIG. 3, in this embodiment the BLU is a direct type BLU having a prism sheet 10, a diffuser sheet 9, one or more rows of a light source 6 electrically connected to a PCB 7, a light guide plate 8, a reflective film 1, and an anisotropic heat dissipation layer 2. Heat from the light source 6, for example, about 95% of the heat from the light source 6, can be discharged to the PCB 7, which has an upper surface 7A and a lower surface 7B. The rows of light source 6 are parallel to one another and are positioned at the predetermined interval from the lower surface of the light guide plate 8B. The light source 6 is electrically connected with the upper surface of the PCB 7A. The reflective film 1 is interposed between the bottom surface of the PCB 7B and the upper surface of the anisotropic heat dissipation layer 2A.

Again referring to FIG. 2, the bottom surface of the anisotropic heat dissipation layer 2B can be connected with an insulating film 5. In another embodiment, as illustrated in FIG. 3, the bottom surface of the anisotropic heat dissipation layer 2B is not connected with an insulating film 5.

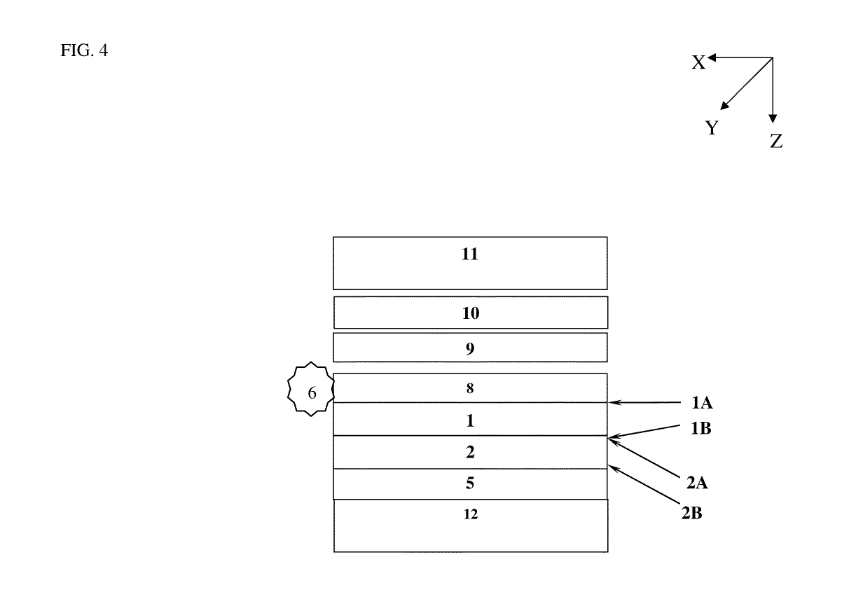

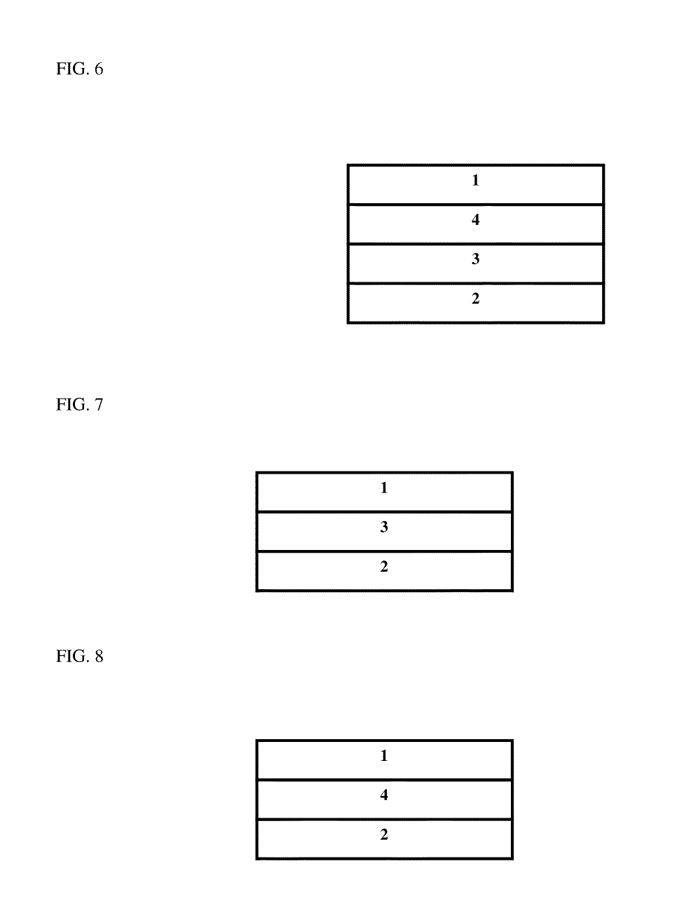

Referring more specifically to FIG. 6, in this embodiment there is a metal layer 3 and an adhesive 4 interposed between the reflective film 1 and the anisotropic heat dissipation layer 2. In another embodiment, as illustrated in FIG. 7, there is a metal layer 3 interposed between the reflective film 1 and the anisotropic heat dissipation layer 2. In yet another embodiment, as illustrated in FIG. 8, there is an adhesive 4 interposed between the reflective film 1 and the anisotropic heat dissipation layer 2. In yet another embodiment, the reflective film 1 and the anisotropic heat dissipation layer 2 are on the same side of the heat source, as illustrated on FIGS. 3 and 4. In yet another embodiment, the reflective film 1 and the anisotropic heat dissipation layer 2 are not spaced apart at a predetermined interval.

### The Anisotropic Heat Dissipation Layer

The anisotropic heat dissipation layer has a higher thermal conductivity in a planar direction (e.g. in the x-y direction as illustrated, for example, in FIG. 2) than that in the through direction (e.g., in the z direction as illustrated, for example, in FIG. 2). In an exemplary embodiment, the thermal conductivity in a planar direction is substantially higher than that in the through direction. In one embodiment, the anisotropic heat dissipation layer is a graphite sheet. In another embodiment, the anisotropic heat dissipation layer is a graphite sheet substantially free of binder, curing agent and filler. In another embodiment, the anisotropic heat dissipation layer is a graphite sheet devoid of binder, curing agent and filler. In another embodiment, the anisotropic heat dissipation layer comprises a metal layer and an insulating film. By forming the heat dissipation layer in this manner, the anisotropic thermal conductivity is achieved by the juxtaposition of high (metal) and low (insulating film) thermal conductivity materials.

In other embodiments, as illustrated in FIG. 6 and FIG. 7, one of the major surfaces of the anisotropic heat dissipation layer 2 is electroplated with a metal layer 3, substantially free of any soft plastic film. Additionally, the edges of the anisotropic heat dissipation layer are not electroplated with a metal layer and are substantially free of any soft plastic film.

### Graphite Sheet

In some embodiments, the graphite sheet can be prepared from natural, synthetic or pyrolytic graphite particles. Thus, an exemplary embodiment, it is a natural, synthetic or pyrolytic graphite particle-based graphite sheet. An example of natural graphite used in at least some embodiments includes, but is not limited to, flexible exfoliated graphite (made by treating natural graphite flakes with substances that intercalate into the crystal structure of the graphite). In one embodiment, the graphite sheet is substantially free of the following: a binder (e.g., polyester resin, urethane resin, epoxy resin, acryl resin etc.), a curing agent (e.g., epoxy resin curing agent), a filler (e.g., Al₂O₃, Al, Bn and Cu coated with Ag), a dispersing agent (e.g., polyamine amide based material, phosphoric acid ester based material, polyisobutylene, oleic acid, stearin acid, fish oil, ammonium salt of a polycarboxylic acid, sodium carboxymethyl), a solvent (e.g., methyl ethyl ketone, ethanol, xylene, toluene, acetone, trichloroethane, butanol, methyl isobuthyl ketone (MIBK), ethyl acetate, butyl acetate, or cyclo hexanone), a leveling agent (e.g., polyacrylate based material), a wetting agent, polybasic acid and/or acid anhydride. In another embodiment, the graphite sheet consists essentially of flexible exfoliated graphite particles.

The thermal conductivity of the graphite sheet is anisotropic, i.e., high in the direction parallel to the major faces of the flexible graphite sheet (in-plane conductivity) and substantially less in the direction transverse to the major surfaces of the graphite sheet (through-plane conductivity). In an exemplary embodiment, the anisotropic ratio of the graphite sheet, defined as the ratio of in-plane conductivity to through-plane conductivity, is between about 2 to about 800. In another exemplary embodiment, the graphite sheet is about 0.01 mm to about 0.5 mm.

### Reflective Film

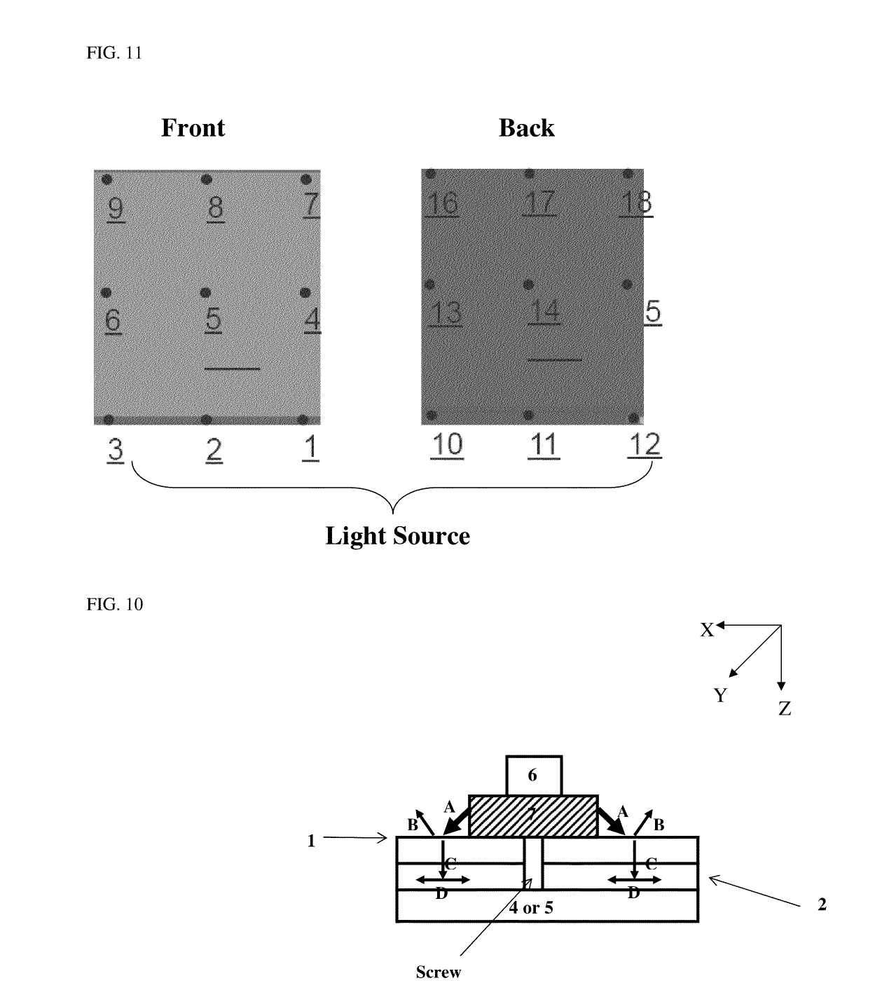

In some embodiment, the reflective film reflects light emitted from the light source and at least one of attenuates or enhances heat radiation. In some other embodiments, the reflective film is configured to reflect heat energy. As illustrated by way of example in FIG. 10, the heat from the light source 6 hits the reflective film 1 (Pathway A). The reflective film reflects a portion of the heat from the heat source to the surrounding atmosphere (Pathway B). This reduces the amount of heat passing through the anisotropic heat dissipation layer (pathway C).

In an exemplary embodiment, the performance characteristics detailed herein are related to heat radiation/heat energy that corresponds to the infrared part of the electromagnetic spectrum. In an exemplary embodiment, the performance characteristics detailed herein are related to heat radiation/heat energy that corresponds to radiation having a wavelength of more than about 750 nm and/or between about 750 nm to about 1 mm. In an exemplary embodiment, the performance characteristics detailed herein are related to radiation outside the visible wavelengths (e.g., a wavelength of 950 nm).

The reflective film comprises a base material with a reflective layer. A protection layer is optionally disposed on the reflective coating to avoid oxidation of the reflective coating.

The base material can be a glass, a plastic, a polymer (e.g., polyethylene terephthalate or PET) or a metal such as aluminum. A wide variety of reflective material can be used as the reflective layer. The reflective material having utilitarian value in at least some embodiments includes one or more layers of indium, tin, gold, platinum, zinc, silver, copper, titanium, lead, an alloy of gold and beryllium, an alloy of gold and germanium, nickel, an alloy of lead and tin, an alloy of gold and zinc or other similar materials or combinations thereof, or one or more layers of polymer (e.g., PET). In one exemplary embodiment, the reflective layer includes silver. In another exemplary embodiment, the reflective layer includes PET. In another exemplary embodiment, the reflective coating is substantially free of optical fiber.

The protection layer comprises an antioxidant such as metal oxides, silicon oxides, metal nitrides, silicon nitrides and other appropriate antioxidants.

The reflective film can have, in some embodiments, a reflectivity of at least 70% as measured by CIR l*a*b* using D65 light source (6500K) and the thickness is about 0.05 mm to about 0.5 mm and/or a reflectivity as otherwise detailed herein and the thickness is about 0.05 mm to about 0.5 mm.

### Metal Layer

In one embodiment, one of the major surfaces of the anisotropic heat dissipation layer 2 is in direct contact or indirect contact with a metal layer 3. In one embodiment, the metal layer is electroplated onto the graphite sheet according to the method disclosed in U.S. Pub. No. 2010/0243230, which is incorporated herein by reference in its entirety. In an exemplary embodiment, the graphite sheet is cleaned with an acid solution, followed by electroplating the metal on the graphite sheet. Alternatively and/or in addition to this, the metal layer is adhered to the graphite sheet using a double-sided adhesive.

The metal layer according to at least some embodiments is isotropic in nature and comprises one or more layers of copper, nickel, chromium, gold, silver, tin platinum or other similar materials or combinations thereof. The metal layer has a thickness of no less than about 1 μm.

In an exemplary embodiment, the metal layer includes two layers wherein a cooper layer having a thickness ranging from 8 μm to 10 μm is electroplated on the graphite sheet, and a nickel film having a thickness ranging from 2 μm to 5 μm is electroplated on the copper film.

Due to its isotropic nature, the metal layer can effectively conduct heat from the reflective film to the anisotropic heat dissipation layer. The metal layer also prevents flaking of graphite particles.

### Adhesive

In one embodiment, the BLU further comprises a double-sided adhesive 4 for adhering the anisotropic heat dissipation layer 2 to the reflective film 1 (as illustrated in FIG. 8) or for adhering the metal layer 3 to the reflective film 1 (as illustrated in FIG. 6).

In another embodiment, the BLU further comprises a double-sided adhesive for adhering the lower surface of the PCB to the upper surface of the reflective film.

In yet another embodiment, the direct type BLU further comprises a double-sided adhesive on the lower surface of the anisotropic heat dissipation layer.

The adhesive is a double-sided adhesive tape, including a pressure sensitive adhesive coating and a release liner. The thickness of the adhesive is about 0.005 mm to about 0.05 mm. Examples of suitable adhesives having utilitarian value in at least some embodiments include, but are not limited to, 3M 6T16 adhesive and 3M 6602 adhesive, both are commercially available from 3M, USA.

### Insulating Film

Suitable materials for the insulating film 5 include, but are not limited to, resin, polyester (e.g., PET) and polyimide materials. An exemplary material having utilitarian value is PET, with a thickness of about 0.001 mm to about 0.05 mm. The insulating film 5 can be applied to lower surface of the anisotropic heat dissipation layer by various methods known in the field, such as by coating, using a hot laminating process, or by adhesion. The insulating film electrically insulates the anisotropic heat dissipation layer and prevents graphite flaking.

### The Light Source

The light source in the BLU includes, but is not limited to, LED (light emitting diode), LCD, and OLED (organic light emitting diode).

### The Display Device

In an exemplary embodiment, a display device including a display panel and a backlight unit described herein is provided.

In an exemplary embodiment, as illustrated in FIG. 4, the display device including a display panel 11, an edge type backlight unit as illustrates in FIG. 2, and a housing 12. The display panel 11 is positioned above the prism sheet 10, the diffuser sheet 9, and the light guide plate 8. The housing 12 is positioned at a predetermined interval from the lower surface of the anisotropic heat dissipation layer 2B.

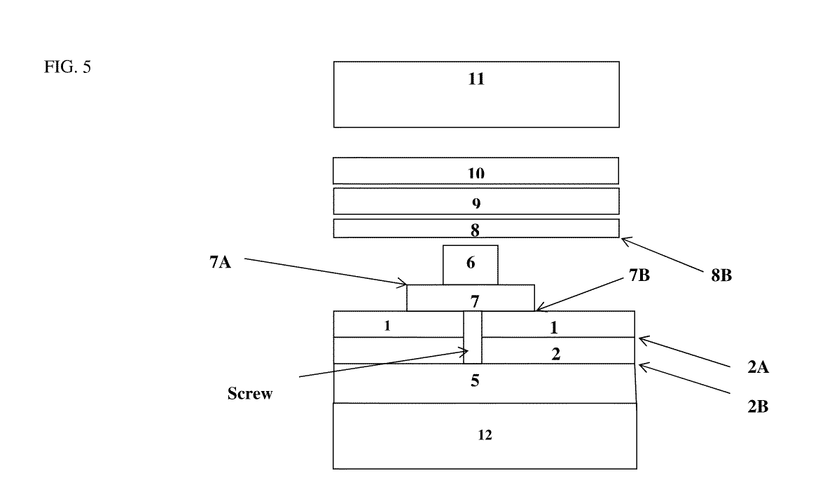

In another exemplary embodiment, as illustrated in FIG. 5, the display device including a display panel 11, a direct type backlight unit as illustrates in FIG. 3, and a housing 12. The display panel 11 is positioned above the prism sheet 10, the diffuser sheet 9, and the light guide plate 8. The housing 12 is positioned at a predetermined interval from the lower surface of the anisotropic heat dissipation layer 2B.

In one embodiment, as illustrated in FIG. 4, an insulating film 5 is interposed between the lower surface of the anisotropic heat dissipation layer 2B and the housing 12. In another embodiment, as illustrated in FIG. 5, there is no insulating film in the backlight unit.

### The Method of Heat Dissipation

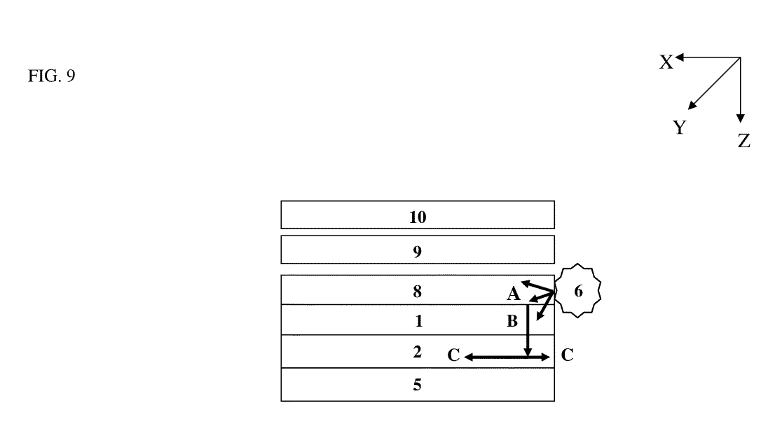

FIG. 9 illustrates the thermal conductive pathway of an edge type BLU and methods to dissipate heat and reduce the internal temperature of the BLU. An anisotropic heat dissipation layer 2 is placed in direct physical contact or indirect contact (wherein there is a gap or one or more interposing layers) with a reflective film 1 in an edge type BLU. Heat is first conducted from a light source 6 to a light guide plate 8 (pathway A), then conducted from the light guide plate 8 to the reflective film 1 and the anisotropic heat dissipation layer 2 (pathway B). Heat is then dissipated through the planar direction (i.e., X-Y direction) of the anisotropic heat dissipation layer 2 (pathway C).

FIG. 10 illustrates the thermal conductive pathway of a direct type BLU and methods to dissipate heat and reduce the internal temperature of such BLU. An anisotropic heat dissipation layer 2 is placed in direct physical contact or indirect contact (wherein there is a gap or one or more interposing layers) with a reflective film 1, wherein the anisotropic heat dissipation layer 2 is positioned below the reflective film 1 and the reflective film 1 is positioned below a PCB 7. Heat from the PCB is reflected to the ambient environment by the reflective film 1 (pathway A), wherein a portion of the heat is reflected to the ambient air (pathway B) and the remaining heat passes through the thickness of the reflective film 1 (with or without) the metal layer in Z direction (pathway C), then spreads through the planar direction (i.e., X-Y direction) of the anisotropic heat dissipation layer 2 (pathway D).

The following example further illustrates an exemplary embodiment. This example is intended merely to be illustrative of some exemplary embodiments and is not to be construed as being limiting.

### EXAMPLE 1

### Thermal Study of an Edge Type BLU using the Anisotropic Heat Dissipation Layer

An edge type BLU as illustrated in FIG. 2 was modeled for this study. FIG. 11 illustrates the temperature measurement points as follow: points 1, 2, 3, 10, 11 and 12 correspond to the measurement points of the light source; points 4-9 correspond to the measurement points on the upper surface of the light guide plate and points 13-18 correspond to the measurement points on the lower surface of the light guide plate. LED lights were used as the light source in this thermal study and the BLU was running for 2 hours prior to temperature measurement.

In the first thermal study, no anisotropic heat dissipation layer was used and the temperatures at various measurement points were taken and illustrated in Table 1.

In the second thermal study, an anisotropic heat dissipation layer made of flexible graphite sheet, and electroplated with a metal layer (a copper layer on top of the graphite sheet and a nickel layer on top of the copper layer) was placed below the reflective film, wherein the nickel layer is connected to the lower surface of the reflective film and the copper layer is connected to the graphite sheet. The thickness of the graphite sheet and the metal layer is about 0.07 mm. The temperature at various measurements point were taken and illustrated in Table 2.

The thermal study was conducted in two edge type BLUs. The thermal data from the first edge type BLU is listed in column S1 and the thermal data from the second edge type BLU is listed in column S2.

In the edge type BLU without the graphite sheet (see Table 1), the average maximum recorded temperature of the light source at point 2 was 50.85° C. and at point 11 was 50.8° C. In the edge type BLU with the graphite sheet and metal layer for heat dissipation (see Table 2), the average maximum recorded temperature of the light source at point 2 was 39.1° C. and at point 11 was 40.15° C. The use of the graphite sheet+metal layer in a BLU reduced the maximum temperature of the light source by 11.75° C. at point 2 and 10.65° C. at point 11.

The results show that the anisotropic heat dissipation layer of at least some exemplary embodiments is more efficient in dissipating heat in a BLU compare to a BLU without the anisotropic heat dissipation layer.

TABLE 1

Temperature
(° C.)

| Location | S1 | S2 | Average |
|---|---|---|---|
| 1 | 46.1 | 44.7 | 45.40 |
| 2 | 50.4 | 51.3 | 50.85 |
| 3 | 42.5 | 45.2 | 43.85 |
| 4 | 24.7 | 23.5 | 24.10 |
| 5 | 24.5 | 23.4 | 23.95 |
| 6 | 24.7 | 23.2 | 23.95 |
| 7 | 24.5 | 22.9 | 23.70 |
| 8 | 24.3 | 22.9 | 23.60 |
| 9 | 24.1 | 23.1 | 23.60 |
| 10 | 45.8 | 44.9 | 45.35 |
| 11 | 50.6 | 51.0 | 50.80 |
| 12 | 41.4 | 43.6 | 42.50 |
| 13 | 24.5 | 23.2 | 23.85 |
| 14 | 24.2 | 23.3 | 23.75 |
| 15 | 24.5 | 23.3 | 23.90 |
| 16 | 24.4 | 22.9 | 23.65 |
| 17 | 24.2 | 22.9 | 23.55 |
| 18 | 23.9 | 22.8 | 23.35 |

TABLE 2

Temperature
(° C.)

| Location | S1 | S2 | Average |
|---|---|---|---|
| 1 | 38.9 | 38.3 | 38.60 |
| 2 | 38.9 | 39.3 | 39.10 |
| 3 | 40.3 | 39.1 | 39.70 |
| 4 | 36.5 | 25.3 | 30.90 |
| 5 | 25.5 | 25.5 | 25.50 |
| 6 | 24.5 | 25.2 | 24.85 |
| 7 | 24.5 | 24.4 | 24.45 |
| 8 | 24.3 | 24.4 | 24.35 |
| 9 | 24.2 | 24.2 | 24.20 |
| 10 | 37.5 | 38.8 | 38.15 |
| 11 | 40.5 | 39.8 | 40.15 |
| 12 | 37.3 | 39.6 | 38.45 |
| 13 | 24.9 | 25.4 | 25.15 |
| 14 | 25.0 | 25.3 | 25.15 |
| 15 | 25.0 | 25.2 | 25.10 |
| 16 | 24.3 | 25.2 | 24.75 |
| 17 | 24.2 | 24.2 | 24.20 |
| 18 | 24.1 | 24.0 | 24.05 |

What is claimed is:

1. A backlight unit, comprising:
a light source;
a light guide plate;
a reflective film; and
a means for anisotropically dissipating heat.

2. The backlight unit of claim 1, further comprising:
a printed circuit board positioned below said light source, wherein
the reflective film is configured to reflect heat.

3. The backlight unit of claim 1, wherein the reflective film has a reflectivity of at least 70%.

4. The backlight unit of claim 1, further comprising:
a housing; and
means for electrically insulating at least one of (i) the light guide plate, (ii) the reflective film and (iii) the means for anisotropically dissipating heat from the housing.

5. The backlight unit of claim 1, wherein the means for anisotropically dissipating heat is substantially free of binder, curing agent and filler.

6. A method for reducing the temperature of a backlight unit, which comprises the following actions:
(a) conducting heat from a light source to a light guide plate;
(b) conducting the heat conducted to the light guide plate from said light guide plate to said reflective film and said anisotropic heat dissipation layer; and
(c) dissipating the heat through the planar direction of said anisotropic heat dissipation layer.

7. The method of claim 6, wherein said anisotropic heat dissipation layer is graphite.

8. A method for reducing the temperature of a backlight unit, which comprises the following actions:
(a) conducting heat from a light source to a printed circuit board;
(b)conducting the heat conducted to the printed circuit board to a reflective film, wherein a portion of the heat is reflected into the ambient air by said reflective film; and
(c) a portion of the heat is dissipated to an anisotropic heat dissipation layer through the planar direction.

9. The method of claim 8, wherein said anisotropic heat dissipation layer is graphite.
